(19) United States
(12) Patent Application Publication
(10) Pub. No.: US 2012/0023150 A1
(43) Pub. Date: Jan. 26, 2012

(54) METHOD FOR PUBLISHING INFORMATION

(75) Inventor: Gary Kung, Santa Ana, CA (US)

(73) Assignee: I/O INTERCONNECT, LTD., Santa Ana, CA (US)

(21) Appl. No.: 13/188,800

(22) Filed: Jul. 22, 2011

Related U.S. Application Data
(60) Provisional application No. 61/366,994, filed on Jul. 23, 2010.

(51) Int. Cl. G06F 15/16

(52) U.S. Cl. 709/202

(57) ABSTRACT

A method for controlling a host apparatus is provided. The method checks whether or not an external storage device is connected to an asserted connection port, first. When the external storage device is connected to the asserted connection port, a data transmission link is built. Then, the method would checks whether or not an external data having a predetermined format is saved in the external storage. If the external data having the predetermined format is saved in the external storage device, the external data would be read from the external storage device through the data transmission link. In addition, the external data having the predetermined format is transmitted to a social website through the internet for publishing the external data on the social website.

### CROSS-REFERENCE TO RELATED APPLICATIONS

The application claims priority of U.S. provisional patent application Ser. No. 61/366,994 filed on Jul. 23, 2010, the contents of which are hereby incorporated by reference.

### FIELD OF THE INVENTION

The present invention relates to a method for publishing information, and more particularly to a method for publishing information on a social website automatically.

### BACKGROUND OF THE INVENTION

Following the social website develops more and more popular, a plurality of information, such as articles, AV files, pictures, etc., can be shared on the social website. Additionally, more and more applications on the social website are developed, for example, online game, group shopping, advertising, etc. Therefore, the influence of the social website becomes more powerful.

FIG. 1 is a flow chart for a user to share information on a social website according to prior art. Referring to the FIG. 1, when a user wants to share information on a website, first, the user needs operating a local host, such as a desktop computer, to link to the social website through the internet, as description in the step S102. Then, the user needs performing the step S104 to input the personal identification data to log in the social website. Meanwhile, the user can execute a sharing operation of the social website, as description in the step S106. So that, the social website would provide a selection window to allow the user selecting at least one file which is saved into the local host, as description in the step S108. Finally, as description in the step S110, the user can upload the selective file to the social website.

As the above maintained, the conventional procedure for uploading file to the social website is not easy to someone who has insufficient knowledge of operating computer. Therefore, someone having insufficient knowledge of operating computer cannot enjoy the fun of the social website conveniently.

### SUMMARY OF THE INVENTION

Therefore, the present invention is to provide a method for controlling a host apparatus for sharing information on a social website.

A method for controlling a host apparatus is provided by the present invention. The method checks whether or not an external storage device is connected to an asserted connection port, first. When the external storage device is connected to the asserted connection port, a data transmission link is built. Then, the method would checks whether or not an external data having a predetermined format is saved in the external storage. If the external data having the predetermined format is saved in the external storage device, the external data would be read from the external storage device through the data transmission link. In addition, the external data having the predetermined format is transmitted to a social website through the internet for publishing the external data on the social website.

In one embodiment of the embodiment, the external data having the predetermined format comprises at least one of an AV file, an audio file, or an image file.

Since the present invention can read the external data from the external storage device and transmit the external data to the social website once the external storage device connecting with the host apparatus, any one even having insufficient knowledge of operating computer can share information on the social website easily.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a flow chart for a user to share information on a social website according to prior art.

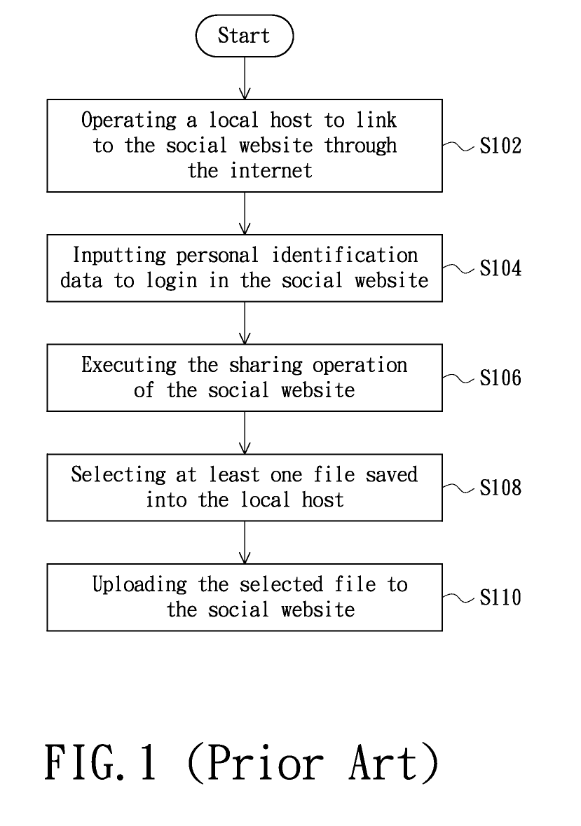

FIG. 2 is a system block diagram of a host apparatus according to one preferred embodiment of the present invention.

FIG. 3 is a flow chart for publishing information according to one preferred embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

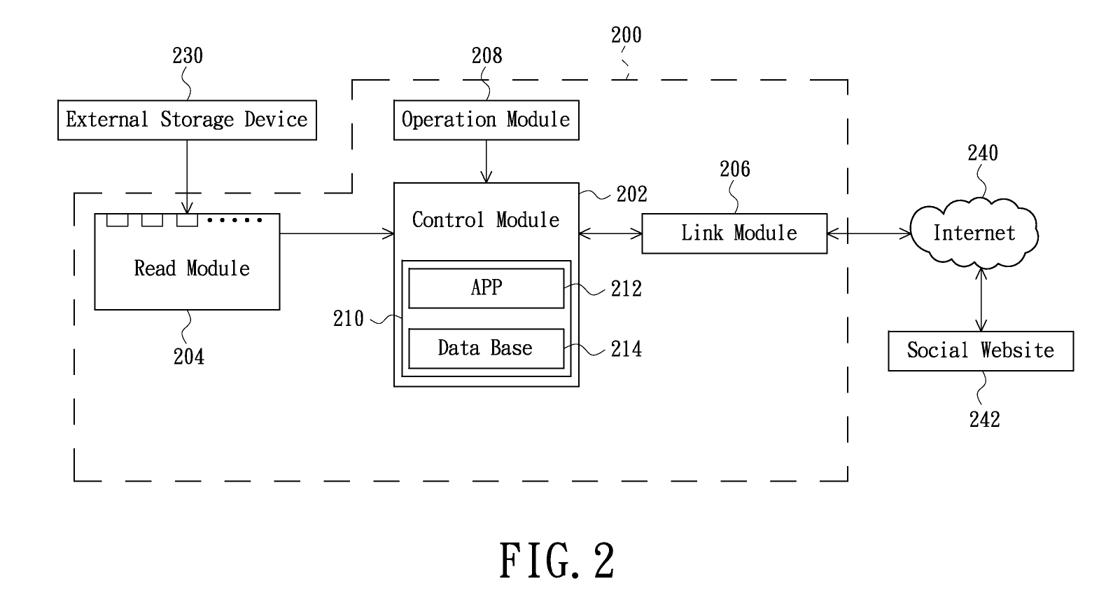

FIG. 2 is a system block diagram of a host apparatus according to one preferred embodiment of the present invention. Referring to the FIG. 2, the host apparatus 200 of the present invention is probably a desktop computer, a portable computer, a package computer, a tablet computer, a mobile device, a smart phone, a print, a camera, a television, a set-top box, a game machine, etc. In the exemplary embodiment, the host apparatus 200 has a control module 202, a read module 204, a link module 206, and a control means 212. Wherein, the control module 202 couples to the read module 204 and the link module 206, and communicates with the control means 212.

In some embodiments, the control means 212 is implemented by a soft production, such as an application program, and saved into a storage unit 210. The storage unit 210 is probably an internal hard disk, a flash memory, etc. In addition, the storage 210 is coupled to the control module 202.

In this embodiment, the host apparatus 200 further comprises an operation module 208. The operation module 208 has at least one operation unit, such as real keys, touch-control units, a joystick, a roll wheel, a roll disk, etc. In some embodiments, the operation module 208 has a hot key, which is introduced in following paragraphs.

Additionally, the read module 204 can links with an external storage device 230. In particularly, the read module 204 has a plurality of connection ports, such as 222, 224 and 226. The connection ports probably comprise a memory card slot, a USB connection port, a HDMI connection port, etc. In particularly, one of the connection ports is an asserted connection port, such like the connection port 226, which is probably a memory card slot for containing a memory card. Therefore, in these embodiments, the external storage device 230 is implemented by a memory card, such like a PCMCIA card, a CF card, a SD card, a mini SD card, a micro SD card, a SDHC card, SDXC card, a T Flash card, a MMC card, a MMCplus card, a HC MMCplus card, a RS-MMC card, a MS card, a SM card, an xD card, a SDXC card, a MS XC card, a Eye-Fi card, etc.

In other embodiments, the asserted connection port also can be a USB connection port, a HDMI connection port, etc. Thus, the external storage device 230 is also probably a flash memory storage device with a USB connector for inserting into a USB port.

Furthermore, the read module 204 is implemented by an optical read module, such as a CD-ROM, a VCD-ROM, a DVD-ROM, etc. Correspondingly, the external storage device 230 is implemented by an optical media, such like a CD disk, a VCD disk, a DVD disk, etc.

In addition, the link module 206 is configured for linking to the internet 240. Therefore, the link module 206 is probably implemented by a network card, a 3G communication unit, a 4G communication unit, a WiFi communication unit, etc.

When the control means 212 is started, the control means 212 makes the control module 202 to control the link module 206 linking to a social website 242 via the internet 240. Then, the control means 212 would log in the social website 242. In this exemplary embodiment, a data base 214 is established into the storage unit 210. In addition, an identification data containing the user's account and password is saved into the storage unit 210. Therefore, the control means 212 can log in the social website 242 according to the identification data saved into the data base 214.

Furthermore, the control means 212 would check whether or not the external storage device 230 connects to the asserted connection port 226. If the external storage device 230 connects to the asserted connection port 226, the control means 212 would wait an upload request. Meanwhile, if, the control means 212 receives the upload request, such as the said hot key in the operation module 208 being pressed, the read module 204 is controlled by the control means 212 to read an external data set to upload from the external storage device 230. Wherein, the external data set to upload is probably an AV file, an image file, an audio file, a text file, etc. Then, the control means 212 controls the control module 202 to obtain the external data from the read module 204 and send the external data to the link module 206, so as to transmit the external data to the social website 242 through the internet 240 for publishing.

In other embodiments, at least one of the above steps of login in the social website 242 and checking whether or not the external storage device 230 connects with the read module 204 can be performed after the control means 212 receives the upload request.

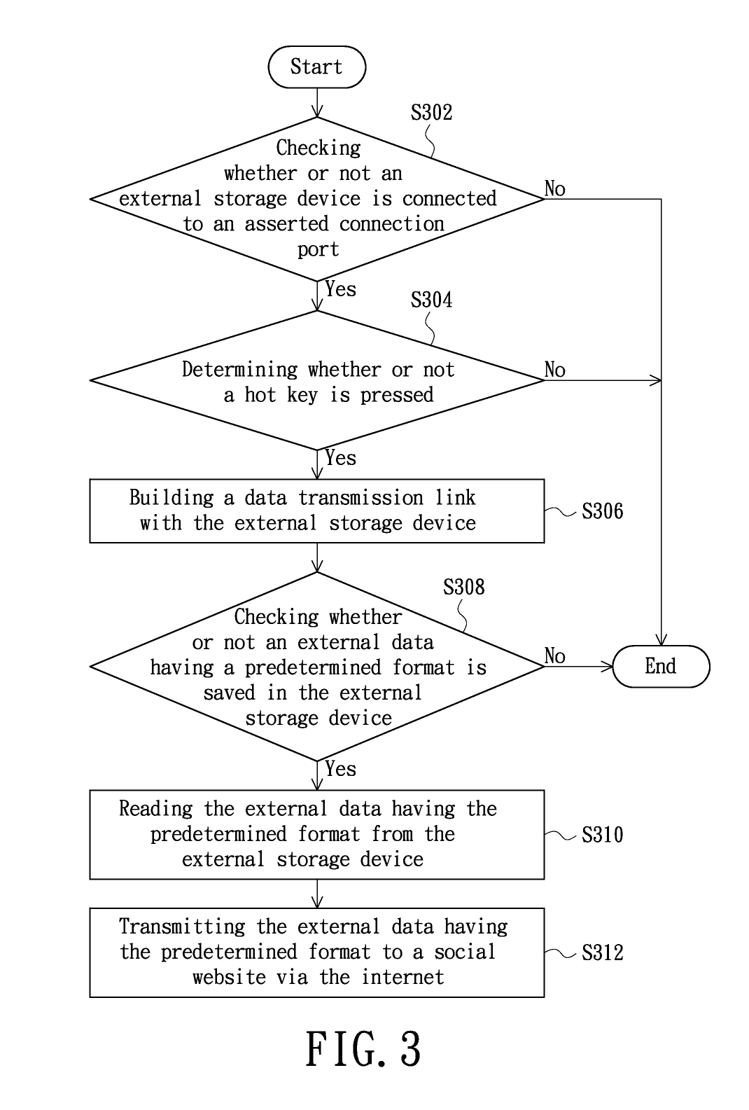

FIG. 3 is a flow chart for controlling a host apparatus according to one preferred embodiment of the present invention. Referring to the FIG. 3, first, the method of the embodiment, first, checks whether or not an external storage device is connected to an asserted connection port configured on the host apparatus, as description in the step S302. When the external storage device is connected to the asserted connection port the method, as description in the step S306, would build a data transmission link with the external storage device. In some embodiments, before the step S306, the method would determine whether or not a hot key configured on the host apparatus is pressed. When the hot key is pressed (i.e., the “yes” labeled on the step S304), the step S306 is executed.

After the step S306, the method performs the step S308 to check whether or not an external data having a predetermined format is saved in the external storage device. If a data having the predetermined format (i.e., the “yes” labeled on the step S308), such as an AV file, an audio file, an image file, a text file, the data having the predetermined format would be read from the external storage device via the data transmission link, as description in the step S310. Then, the step S312 is executed that the external data having the predetermined format is transmitted to a social website via the internet.

In summary, the present would read the external data and send the external data to a social website, once the external storage device links to the host apparatus. Therefore, the user just connects the external storage device to the host apparatus, the external data set to upload would be published on the social website. In another word, any one even having insufficient knowledge of operating computer can share information on the social website.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for controlling a host apparatus, comprising:
checking whether or not an external storage device is linked to an asserted connection port of the host apparatus;
building a data transmission link with the external storage device, when the external storage device is connected to the asserted connection port
checking whether or not an external data having a predetermined format is saved in the external storage device;
reading the external data having the predetermined format from an external storage device through the data transmission link, when the external storage device has the external data having the predetermined format; and
transmitting the external data set to upload to a social website from the host apparatus via the internet for publishing the external data having the predetermined format on the social website.

2. The method according to claim 1, wherein the external data having the predetermined format comprises at least one of an AV file, an audio file, and an image file.

3. The method according to claim 1, further comprising:
checking whether or not a hot key configured on the host apparatus is pressed; and
performing the step of linking the data transmission link, when the host key is pressed.

4. The method according to claim 1, further comprising:
reading an identification data from a data base; and
logging in the social website through the internet according to the identification data, so as to transmit the external data set to upload.

5. A host apparatus, comprising:
a read module, having an asserted connection port for linking to an external storage device;
a link module, configured for linking to the internet;
a control module, coupled to the read module and the link module; and
a storage unit, having an application control program and being coupled to the control module,
wherein when the application control program determines that the external storage device is connected to the asserted connection port, the application control program reads an external data having a predetermined format from the external storage device via the asserted connection port, and makes the control module controlling the link module to upload the external data having the predetermined format to a social website through the internet.

6. The host apparatus according to claim 5, wherein the asserted connection port is a memory card slot for containing at least one memory card.

7. The host apparatus according to claim 6, wherein the memory card is a PCMCIA card, a CF card, a SD card, a mini SD card, a micro SD card, a SDHC card, SDXC card, a T Flash card, a MMC card, a MMCplus card, a HC MMCplus card, a RS-MMC card, a MS card, a SM card, an xD card, a SDXC card, a MS XC card, a Eye-Fi card.

8. The host apparatus according to claim 5, further comprising am operation module having a plurality of operation units.

9. The host apparatus according to claim 8, wherein one of the operation units is a host key.
